(19) United States
(12) Patent Application Publication
(10) Pub. No.: US 2008/0022288 A1
(43) Pub. Date: Jan. 24, 2008

(54) Signal Processing Appatatus

(75) Inventor: Marco Bekooij, Eindhoven (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/628,103

(22) PCT Filed: May 20, 2005
(86) PCT No.: PCT/IB05/51648

§ 371 Date: Nov. 27, 2006

(30) Foreign Application Priority Data
May 27, 2004 (EP) 04102350.8

(51) Int. Cl. G06F 9/46

(52) U.S. Cl. 718/107

(57) ABSTRACT

Signal stream processing jobs contain tasks (100), each task (100) to be performed by repeated execution of an operation that processes a chunk of data from a stream. Each job comprises a plurality of the tasks (100) in stream communication with one another. A plurality of processing units (10), which are mutually coupled for the communication of signal streams execute that tasks. A preliminary computation is performed for each job individually, to determine execution parameters required for the job to support a required minimum stream throughput rate if each task of the job is executed in a respective context wherein opportunities to start execution of the task occur separated at most by a cycle time T defined for the task. At run time combination of jobs is selected for execution. Groups of the tasks of the selected combination of jobs are assigned to respective ones of the processing units (10), checking that for each particular processing unit (10) a sum of worst case execution times for the tasks assigned to that particular processing unit (10) does not exceed the defined cycle time T defined for any of the tasks (100) assigned to the particular processing unit (10). The processing unit (10) execute the selected combination of jobs concurrently, each processing unit (10) time multiplexing execution of the group of tasks (100) assigned to that processing unit (10).

The invention relates to apparatus for processing signal streams, a method of operating such an apparatus and a method of manufacturing such an apparatus.

Signal stream processing is required in equipment for media access, such as television/internet access equipment, graphics processors, camera's, audio equipment etc. Modern equipment requires increasingly vast numbers of stream processing computations to be performed. Stream processing involves processing successive signal units of an (at least in principle) endless stream of such signal units concurrently with arrival of the signal units.

In this type of equipment the implementation of stream processing computations preferably has to meet several demands: it must satisfy real-time signal stream processing constraints, it must be possible to execute flexible combinations of jobs and it has to be able execute a vast amount of computations per second. The real-time stream processing requirement is needed for example to avoid hick-ups in audio rendering, frozen display images, or discarded input audio or video data due to buffer overflow. The flexibility requirement is needed because users must be able to select at run time which arbitrary combination of signal processing jobs that should be executed concurrently, always satisfying the real time constraints. The requirement of a vast amount of computations usually implies that all this should be realized in a system of a plurality of processors that operate in parallel, performing different tasks that are part of the signal processing jobs.

In such a flexible and distributed system it can be extremely difficult to guarantee that real time constraints will be met. The time needed to produce data depends not only on the actual computation time, but also on waiting time spent by processors waiting for input data, waiting for buffer space to become available to write output data, waiting until a processor is available etc. Unpredictable waiting can make real time performance unpredictable. Waiting can even lead to deadlock if processes wait for each other to proceed to produce data and or free resources.

Even if waiting does not seem to hinder real-time performance under normal circumstances, a failure to meet real time constraints may surface only under special circumstances, when the signal data causes some computation task to complete in unusually (but not erroneously) short or long time for a chunk of the stream. Of course, one may simply leave the user to try whether the equipment will be able to support a combination of jobs at all times. But this may have the effect that the user may have to discover afterwards that, say, part of a video signal has not been recorded, or that the system crashes at unpredictable times. Although in some systems consumers have been forced to accept this kind of performance, this is of course highly unsatisfactory.

The use of a theoretical framework called Synchronous Data Flow graphs (SDF) has provided a solution to this problem for individual jobs. The theory behind SDF graphs makes it possible to compute in advance whether it can be guaranteed that real-time constraints or other throughput requirements will be met under all circumstances when tasks of a stream-processing job are implemented distributed over a plurality of processors. The basic approach of SDF graph theory is that an execution time is computed for a set of theoretical processors that execute all tasks in parallel. The SDF graph theory provides a proof that, under certain conditions, the throughput speed (time needed between production of successive parts of a stream) that is computed in for this set of theoretical processors is always slower than the throughput speed of a practical implementation of the tasks. Hence, if a combination of task has been proven to work in real time for the theoretical set of processors, real-time performance can be guaranteed for the practical implementation.

An SDF graph is constructed by splitting a job that must be executed into tasks. The tasks correspond to nodes in the SDF graphs. Typically, each task is performed by repeatedly performing an operation that inputs and/or outputs chunks of one or more streams of input data from or to other tasks. Edges between the nodes of the SDF graph represent communication of streams between tasks. In the set of theoretical processors the operation of each task is executed by a respective one of the processors. The theoretical processors wait for sufficient data before starting execution of the operation. In the SDF model, each stream is assumed to be made up of a succession of “tokens”, each of which corresponds to a respective chunk of the data from the stream. When a specified number of tokens is available at its inputs a processor is assumed to start processing immediately, inputting (removing) the tokens from its inputs, and taking a predetermined time interval before producing a resulting token at its output. For this theoretical model the time points at which the tokens will be output can be computed.

To be able to convert these computed theoretical time points to worst case time points for a practical set processors first of all the duration of the predetermined time intervals required by the theoretical processors must be selected equal to (or larger than) the worst case time intervals needed by the practical processors.

Secondly, the theoretical model has to be “made aware” of a number of limitations of the practical processors. For example, in practice a processor cannot start execution of an operation if it is still processing the operation for a previous token. This limitation can be expressed in the SDF graph by adding a “self edge” from a node back to itself. The processor that corresponds to the node is modelled to require a token from this self-edge before starting execution and to output a token at the end of execution. Of course, during each execution a token from the regular input of the processor is processed as well. The self-edge is initialized to contain one token. In this way, the theoretical set of processors is given the practical property that the start of execution of a task for one token has to wait until completion of execution for the previous token. Similarly the SDF graph can be made aware of practical limitations due to buffer capacity, which may cause a processor to wait when no space is available in an output buffer.

Other limitations of the practical processors are often due to the fact that each processor typically executes operations of a plurality of different tasks in time-multiplexing fashion. This means that in practice the start of execution of operations must wait not only for the availability of tokens, but also for the completion of operations for other tasks that are executed by the same processor. Under certain conditions this limitation can be represented in the SDF graph. In particular, when there is a predetermined order in which the multiplexed tasks will be executed, this can be represented by adding a loop of edges to the SDF graph, from one multiplexed task to the next according to the predetermined order, and by adding one initial token on the first edge of this loop. In this way, the theoretical set of processors is given the practical property that the start of execution of each task in the loop waits for completion of the previous task.

It should be noted that this way of making the SDF graph model “aware” of limitations of practical implementations is not applicable to all possible limitations. For example, if the order in which time-multiplexed tasks are executed by a processor is not predetermined, the consequences for timing cannot be expressed in an SDF graph. Thus, for example, if a processor is arranged to skip a particular task (proceeding to the next task) if there are insufficient tokens to start the particular task, the effect cannot be expressed in the SDF graph. In practical terms this means that it is not possible to guarantee real time throughput in this case. Consequently the real time guarantees comes at a price: only certain implementations can be used. In general it can be said that, in order to fit into SDF graph theory, the implementation must satisfy a “monotonicity condition”: faster execution of a task should never lead to later execution of any other task.

Moreover, it should be noted that it is difficult to apply SDF graph theory to execution of a flexible combination of a plurality of jobs in parallel. In principle this would require the tasks of all different jobs that are executed in parallel to be included in the same SDF graph. This is needed to express the mutual effect of the tasks on each others' timing. However, if the input and/or output data rate of different jobs is not synchronized it becomes impossible to provide real time guarantees in this way. Moreover, performing a new computation of throughput times every time when a job is added or removed from the set of jobs that has to be executed in parallel, presents a considerable overhead.

Among others, it is an object of the invention to provide for real-time guarantees using SDF graph theory techniques which can be applied at run-time with little overhead.

Among others, it is an object of the invention to reduce the amount of computations needed to provide real-time guarantees using SDF graph theory techniques, when flexible combinations of jobs must be executed with a set of processors.

Among others, it is an object of the invention to provide for real-time guarantees when flexible combinations of unsynchronized jobs must be executed with a set of processors.

Among others, it is an object of the invention to make it possible to provide for real-time guarantees in a multi-processor circuit wherein a processor executes a plurality tasks on a round robin basis, proceeding with a next task in the round robin sequence if insufficient input data is available for a previous task.

Among others, it is an object of the invention to provide for real-time guarantees using SDF graph theory techniques with less waste of resources.

The invention provides for a device according to Claim 1 and a method according to Claim 4. According to the invention real time throughput for a plurality of concurrently executed stream processing jobs is guaranteed by using a two-stage process. In a first stage the individual jobs are considered in isolation and the execution parameters for these jobs, such as for example the buffer sizes for buffering data from the streams between tasks, are selected for an assumed context wherein opportunities to start execution of the task occur separated at most by a cycle time T defined for the task. Preferably, it also checked whether the job can be executed according to the required real time requirements, i.e. whether it will produce successive chunks of data with at most a specified delay. In the first stage it need not be known which combination of stream processing jobs must be executed concurrently.

In a second stage, the combination of concurrently executed processing jobs is considered. At this stage each of a plurality of processing units is assigned a group of the tasks from the selected combination of jobs. During assignment it is checked that for each particular processing unit a sum of worst case execution times for the tasks assigned to the particular processing unit does not exceed the defined cycle time T defined for any of the tasks assigned to the particular processing unit. The sum reflects how the worst case execution times affect the maximum possible delay between successive opportunities to excecute, given the scheduling algorithm used by the processing unit for the tasks (e.g. Round Robin scheduling). Finally the selected combination of jobs is executed concurrently, time multiplexing execution of the cycles of tasks on the respective processing units. Typically, it is not needed that the processing units wait until a task can be executed. If the invented process for guaranteeing real time performance is used, the processing unit may skip to the next task if a task cannot proceed due to lack of input and/or output buffer space. This is particularly advantageous to facilitate the performance of different jobs that process mutually unsynchronized data streams.

The cycle times T are preferably selected the same for all tasks. This simplifies operation in the second stage. However, according to a second embodiment the cycle times of selected tasks are adjusted when the real time requirements cannot be met. By reducing a cycle time for a particular task one effectively allows fewer tasks to be executed on the same processing unit as the particular task, to improve performance. Adjustment of the cycle times makes it possible to search for a possible real time implementation in the first stage, i.e. when the combination of tasks that must be executed in parallel may not yet be known.

The required minimum buffer sizes in the assumed context may be computed using SDF graph techniques. In one embodiment the buffer sizes are computed by adding virtual nodes to the SDF graph of a process in front of nodes for real tasks. The worst case execution times of these virtual nodes are set to represent the worst case delay due to waiting until a processing unit reaches a task when a cycle of tasks is executed. Next the buffer sizes are determined by considering all paths through the SDF graph from one node that produces a data stream to another node that consumes that data stream and determining the sum of the worst case execution times of the nodes along each path. The highest of these sums is used to determine the buffer size, by dividing it by the maximum allowable time between successive tokens, as determined by the real time throughput requirement.

These and other objects and advantageous aspects of the invention will be described in more detail using the following figures, which illustrate non-limitative examples of embodiments.

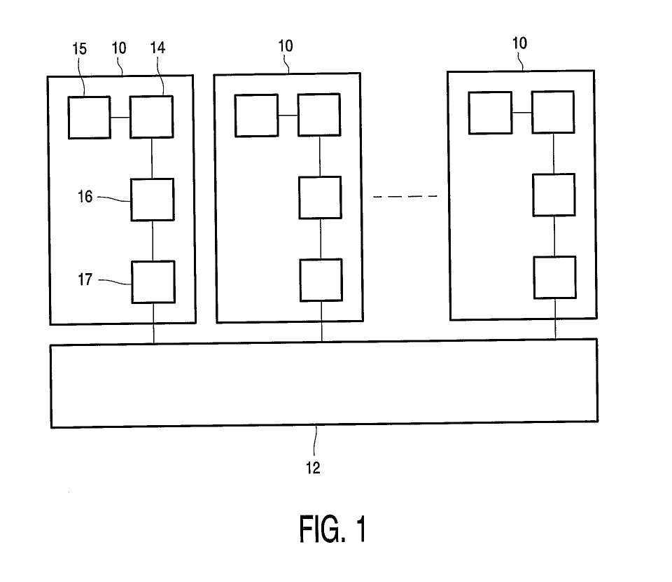

FIG. 1 shows an example of a multi-processor circuit

FIG. 1a-c show SDF graphs of a simple job

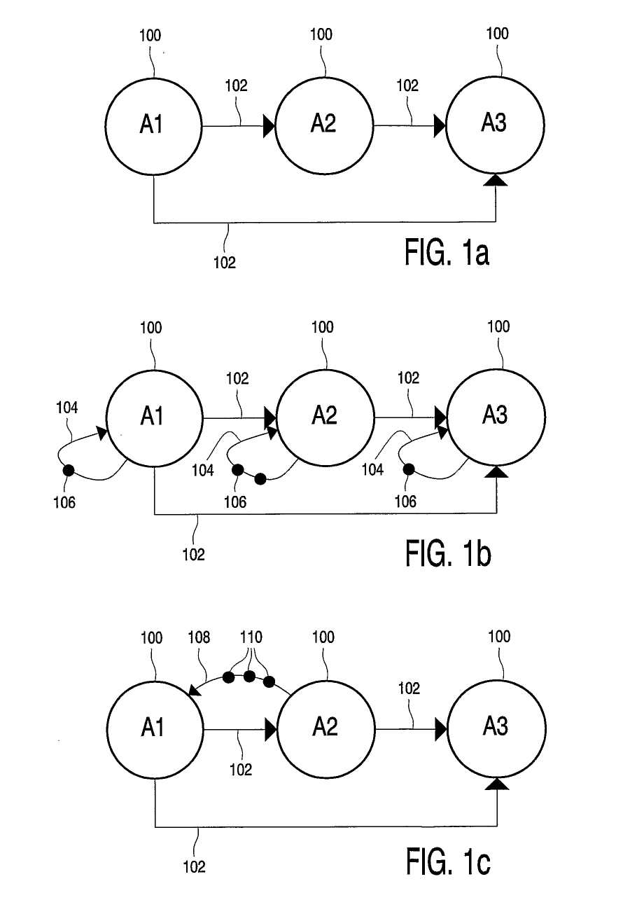

FIG. 2 shows a flow chart of a process for guaranteeing real time performance

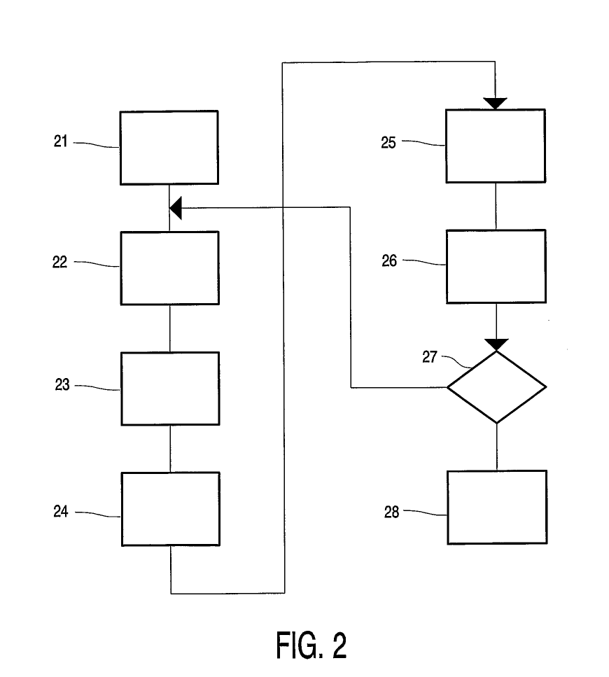

FIG. 3 shows a flow chart of a two-stage process for guaranteeing real time performance

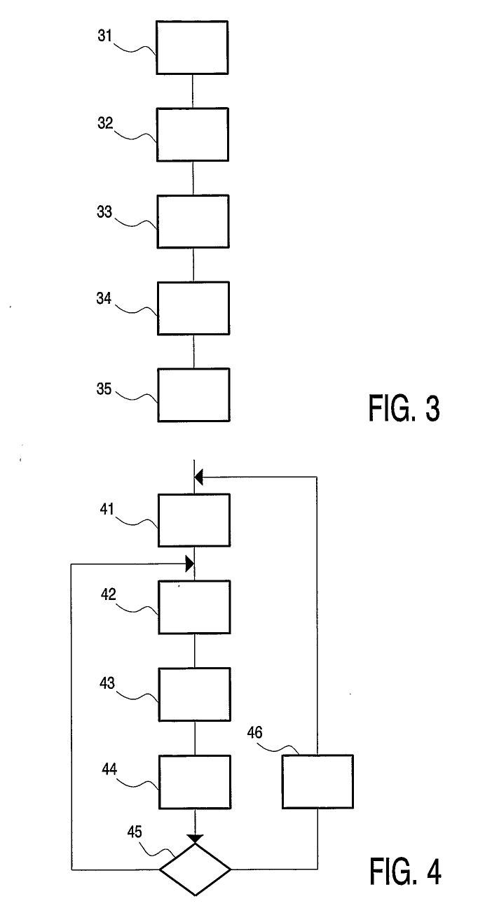

FIG. 4 shows a flow chart of a step in a two-stage process for guaranteeing real time performance

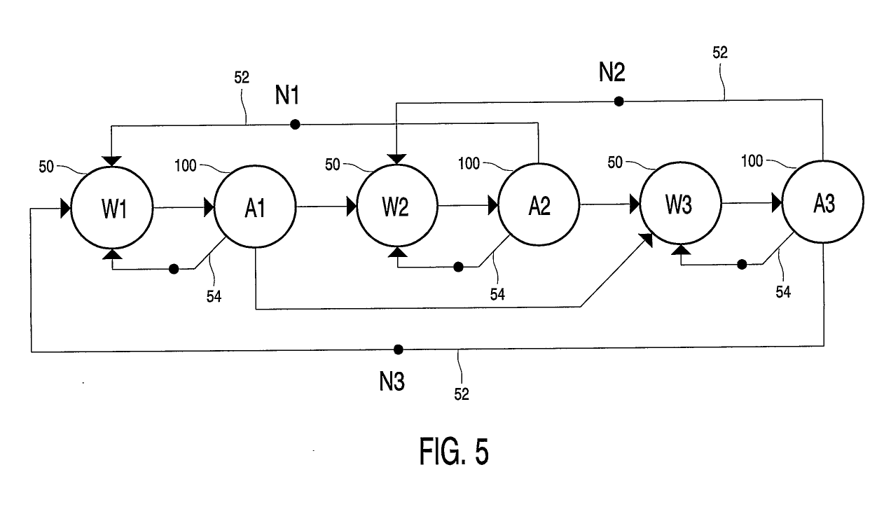

FIG. 5 shows an elaborated SDF graph of a simple job

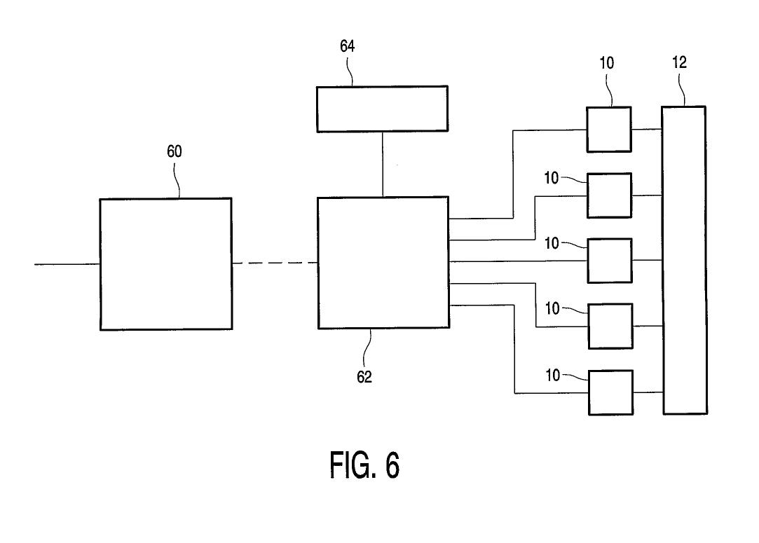

FIG. 6 shows a typical system for implementing the invention

FIG. 1 shows an example of a multi-processor circuit. The circuit contains a plurality of processing units 10 interconnected via an interconnection circuit 12. Although only three processing units 10 are shown it should be understood that a greater or smaller number of processing units may be provided. Each processing unit contains a processor 14, an instruction memory 15, a buffer memory 16 and an interconnection interface 17. It should be understood that, although not shown, processing units 10 may contain other elements, such as data memory, cache memory etc. In each processing unit, processor 14 is coupled to instruction memory 15 and to interconnection circuit 12, the latter via buffer memory 16 and interconnection interface 17. Interconnection circuit 12 contains for example a bus, or a network etc. for transmitting data between the processing units 10.

In operation, the multiprocessor circuit is capable of executing a plurality of signal processing jobs in parallel. A signal processing job involves a respective plurality of tasks, different tasks of a job may be executed by different processing units 10. An example of a signal processing application is an application which involves MPEG decoding of two MPEG streams and mixing of data from the video part of the streams. Such an application can be divided into jobs, such as two MPEG video decoding jobs, an audio decoding job, a video mixing job and a contrast correction job. Each job in turn involves one ore more repeatedly executed tasks. An MPEG decoding job, for example includes a variable length decoding task, a cosine block transform task etc.

The different tasks of a job are executed in parallel by different processing units 10. This is done for example to realize sufficient throughput. Another reason for executing tasks with different processing units may be that some of the processing units 10 may be specialized to perform certain tasks efficiently while other processing units are specialized to perform other tasks efficiently. Each task inputs and/or outputs one or more streams of signal data. The stream of signal data is grouped in chunks of a predetermined maximum size (typically representing signal data for a predetermined time interval, or predetermined part of an image and preferably of predetermined size), which consist for example of a transmission packet, data for a single pixel, or for a line of pixels, an 8×8 block of pixels, a frame of pixels, an audio sample, a set of audio samples for a time interval etc.

During execution of a job, for each task an operation that corresponds to the task is executed repeatedly, each time using a predetermined number of chunks of the stream (e.g. one chunk) as input and/or producing a predetermined number of chunks as output. The input data chunks of a task are generally produced by other tasks and the output data chunks are generally used by other tasks. When a first task outputs stream chunks that are used by a second task, the stream chunks are buffered in buffer memory 16 after output and before use. If the first and second task are executed by different processing units 10, the stream chunks are transmitted via interconnection circuit 12 to the buffer memory 16 of the processing unit 10 that uses the stream chunks as input.

SDF Graph Theory

The performance of the multi-processor circuit is managed on the basis of SDF (Synchronous Data Flow) graph theory. SDF graph theory is largely known per se from the prior art.

FIG. 1a shows an example of an SDF graph. Conceptually SDF graph theory pictures an application as a graph with “nodes” 100 that correspond to different tasks. The nodes are linked by directed “edges” 102 that link pairs of nodes and represent that stream chunks are output by a task that corresponds to a first node of the pair and used by a task that corresponds to a second node of the pair. The stream chunks are symbolized by “tokens”. For each node it is defined how many tokens should be present on its incoming links before the corresponding task can execute and how many tokens the task will output when it executes. After production of a stream chunk and before it is used a token is said to be present on an edge. This corresponds to storage of the stream chunk in a buffer memory 16. The presence or absence of tokens on the edges defines a state of the SDF graph. The state changes when a node “consumes” one or more tokens and/or produces one or more tokens.

Fundamentally an SDF graph depicts data flow and processing operations during execution of a job, tokens corresponding to chunks of the data streams that can be processed in one operation. However, various aspects such as bus access arbitration, limitations on the amount of execution parallelism, limitations on buffer size etc. can also be expressed in the SDF graph.

For example, transmission via a bus or a network can be modelled by adding a node that represents a transmission task (assuming that a bus or network access mechanisms is used that guarantees access within a predetermined time). As another example, in principle any node in the graph is assumed to start execution of a task as soon as sufficient input tokens are available. This implies an assumption that previous executions of the task do not hinder the start of execution. This could be ensured by providing an unlimited number of processors for the same task in parallel. In reality the number of processors is of course limited, often to no more than one, which means that a next execution of a task cannot start before a previous execution is finished. FIG. 1b shows how this can be modelled by adding “self edges” 104 to the SDF graph, each from a node back to itself, with initially a number of tokens 106 on the self edge that corresponds to the number of executions that can be performed in parallel, e.g. one token 106. This expresses that the task can start initially by consuming the token, but that it cannot start again until the task has finished and thereby replacing the token. In practice, it may suffice to add such self-edges only to selected nodes, since limited starting possibilities of the task of one node often automatically imply limitations on the number of times that tasks of linked nodes will be started.

FIG. 1c shows an example, wherein limitations on the size of a buffer for communication from a first task to a second task are expressed by adding a back edge 108 back from the node for the second task to the node for the first task, and by initially placing a number of tokens 110 on this back edge 108, the number of tokens 110 corresponding to the number of stream chunks that can be stored in the buffer. This expresses that the first task can initially execute the number of times that corresponds to the initial tokens, and that subsequent executions are only possible if the second task has finished executions and thereby replaced the tokens.

The SDF graph is a representation of data communication between tasks that has been abstracted from any specific implementation. For the sake of visualization each node can be thought to correspond to a processor that is dedicated to execute the corresponding task and each edge can be thought to correspond to a communication connection, including a FIFO buffer between a pair of processor. However, the SDF graph abstracts from this: it also represents the case where different tasks are executed by the same processor and stream chunks for different tasks are communicated via a shared connection such as a bus or a network.

One of the main attractions of SDF graph theory is that it supports predictions of worst case throughput through the processors that implement the SDF graph. The starting point for this prediction is a theoretical implementation of the SDF graph with self-timed processing units, each dedicated to a specific task, and each arranged to start an execution of the task immediately once it has received sufficient input tokens to execute the task. In this theoretical implementation it is assumed that each processing unit requires a predetermined execution time for each execution of its corresponding task.

For this implementation the start times s(v,k) of respective executions (distinguished by different values of the label k=0, 1,2 . . . ) of a task (distinguished by the label “v”) can be readily computed. With a finite amount of computation the start times s(v,k) for an infinite number of k values can be determined, because the prior art has proven with SDF graph theory that this implementation leads to a repetitive pattern of start times s(v,k):
s(v,k+N)=s(v,k)+λN

Herein N is the number of executions after which the pattern repeats and X is the average delay between two successive executions in the period. i.e. 1/λ is the average throughput rate, the average number of stream chunks produced per unit time.

Prior art SDF graph theory has shown that λ can be determined by identifying simple cycles in the SDF graph (a simple cycle is a closed loop along the edges that contain nodes at most once). For each such cycle “c” a nominal mean execution time CM(c) can be computed, which is the sum of the execution times of the nodes in the cycle, divided by the number of tokens that are initially on the edges in the cycle. λ is the mean execution time CM(cₘₐₓ) of the cycle cₘₐₓ that has the longest mean execution time. Similarly, prior art SDF graph theory has provided a method of computing N, the number of executions in a period. It may be noted that in realistic circumstances the graph will contain at least one cycle, because otherwise the graph would correspond to an infinite number of processors that are capable of executing tasks an infinite number of times in parallel, which would lead to an infinite throughput rate.

The results obtained for the theoretical implementation can be used to determine a minimum throughput rate for practical implementations of an SDF graph. The basic idea is that one determines the worst case execution time for each task in the practical implementation. This worst case execution time is then assigned as execution time to the node that corresponds to the task in the theoretical implementation. SDF graph theory is used to compute the start times sₜₕ(v,k) for the theoretical implementation with the worst case execution times. Under certain conditions it is ensured that these worst case start times are always at least as late as the start of execution sᵢₘₚ(v,k) in the actual implementation:
sᵢₘₚ(v,k)≦sₜₕ(v,k)

This makes it possible to guarantee a worst-case throughput rate and a maximum delay before data is available. However, this guarantee can only be provided if all implementation details that can delay execution of tasks are modelled in the SDF graph. This limits the implementations to implementations wherein the unmodelled aspects have monotonous effects: where a reduction of the execution time of a task can never lead to a delay of the start time of any task.

Scheduling of a Predetermined Combination of Tasks

FIG. 2 shows a flow-chart of a process to schedule a combination of tasks on a processing circuit as shown in FIG. 1 using SDF graph theory. In a first step 21, the process receives a specification of the combination of tasks and the communication between the tasks. In a second step 22 the process assigns the execution of the specified task to different processing units 10. Because the number of processing units in practical circuit is typically much smaller than the number of tasks, at least one of the processing units 10 is assigned a plurality of tasks.

In a third step 23 the process schedules a sequence and a relative frequency in which the tasks will be executed (execution of the sequence being indefinitely repeated at run time). This sequence must ensure the absence of deadlock: it any particular task in the sequence of a processing unit 10 directly or indirectly requires stream chunks from another task executed by the processing unit 10, the other task should be scheduled so often before the particular task that it produces sufficient stream chunks to start the particular task. This should hold for all processors.

In a fourth step 24 the process selects the buffer sizes for storing stream chunks. For tasks that are implemented on the same processing unit 10 minimum values for the buffer sizes follow from the schedule, in that it must be possible to store the data produced by a task before another task uses the data or before the schedule is repeated. Buffer sizes between tasks that can be executed on different processing unit can be selected arbitrarily, subject to the outcome of sixth and seventh step 26, 27, as will be discussed below.

In a fifth step 25 the process effectively makes a representation of an SDF graph, using the specified tasks and their dependencies to generate nodes and edges. Although it will be said colloquially that the process makes an SDF graph and modifies this graph in certain ways, this should be understood to mean that data is generated that represents information that is at least equivalent to an SDF graph, i.e. from which the relevant properties of this SDF graph can be unambiguously derived.

The process adds “communication processor” nodes on edges between nodes for tasks that have been scheduled on different processing units 10 and additional edges that express limitations on the buffer size and the number of executions of tasks can be performed in parallel. Also the process associates a respective execution time ET with each particular node, which corresponds to the sum of the worst-case execution times WCET of the tasks that are scheduled in the same sequence on the same processing unit 10 with the particular task that corresponds to the particular node. This corresponds to the worst case waiting time from possible arrival of input data until completion of execution.

In a sixth step 26 the process performs an analysis of the SDF graph to compute the worst case start times sₜₕ(v,k) for the SDF graph, typically including computation of the average throughput delay λ and the repetition frequency N described above. In a seventh step 27 the process tests whether the computed worst case start times sₜₕ(v,k) meet real time requirements specified for the combination of tasks (that is, that these start time lie before or at specified time points at which stream chunks must be available, which are typically periodically repeating time points, such as time points for outputting video frames). If so, the process executes an eight step 28 loading the program code for the tasks and information to enforce the schedule onto the processing units 10 where the tasks are scheduled, or at least outputting information that will be used for this loading later on. If the seventh step shows that the schedule does not meet the real time requirements the process repeats from the second step 22 with a different assignment of tasks to processing units 10 and/or different buffer sizes between tasks that are executed on different processing units 10.

During execution of the scheduled tasks, when it is the turn of a task in the schedule, the relevant processing unit 10 waits until sufficient input data and output buffer space is available to execute the task (or equivalently the task itself waits once it has been started). That is, deviations from the schedule are not permitted, even if it is clear that a task cannot yet execute and subsequent tasks in the schedule can execute. The reason for this is that such deviations from the schedule could lead to violations of the real time constraints.

Flexible Run Time Combinations of Tasks

FIG. 3 shows a flow chart of an alternative process for dynamically assigning tasks of a plurality of jobs to processing units 10. This process contains a first step 31 in which the process receives a specification of a plurality of jobs. It is not yet necessarily specified in this first step 31 which of the jobs must be executed in combination. Each job may contain a plurality of communicating tasks that will be executed in combination. In a second step 32 the process performs a preliminary buffer size selection for each job individually. First and second step may be performed off-line, prior to actual run time operation.

At run time, the process schedules combinations of jobs dynamically. Typically jobs are added one by one and the process executes a third step 33 in which the process receives a request to add a job to the jobs, if any, executed by the multi-processor circuit. In a fourth step 34, at run-time, the process assigns tasks to the processing units 10. In a fifth step 35 the tasks of the additional job are loaded into the processing units 10 and started (or merely started if they have been loaded in advance).

Preferably, the assignment selected in fourth step 34 specifies respective sequences of tasks for respective processing units 10. During execution of the specified tasks non-blocking execution is used. That is, although the processing units 10 test whether sufficient tokens are available for the tasks in the selected sequence for the processing unit 10, the processing unit 10 may skip execution of a task if insufficient tokens are available and execute a next task in the selected sequence for which sufficient tokens are available. In this way the sequence of execution need not correspond to the selected sequence that is used to test for the availability of tokens. This makes it possible to execute jobs for which the signal streams are not synchronized.

The preliminary buffer size selection step 32 computes an input buffer size for each task. This computation is based on SDF graph theory computations for individual jobs, under the assumption of a worst-case time to execute other jobs on the same processing unit 10.

FIG. 4 shows a detailed flow chart of the preliminary buffer size selection step 32 of FIG. 3. In a first step 41 the process selects a job. In a second step 42 a representation of an initial SDF of the job is constructed including the tasks that are involved in the job. In a third step 43 the process adds nodes and edges to represent practical implementation properties under that assumption that each task will be executed by a processing unit 10 in time multiplexing fashion with as yet unknown other tasks, whose combined worst case execution time does not exceed a predetermined value.

In a fourth step 44 the process performs an analysis of the SDF graph to compute the buffer sizes required between tasks. Optionally the process also computes the worst case start times sₜₕ(v,k) for the SDF graph, typically including computation of the average throughput delay λ and the repetition frequency N described above. In a fifth step 45 the process tests whether the computed worst case start times sₜₕ(v,k) meet real time requirements specified for the combination of tasks (that is, that these start time lie before or at specified time points at which stream chunks must be available, which are typically periodically repeating time points, such as time points for outputting video frames). If so, the process executes a sixth step 46, outputting information including the selected buffer sizes and reserved times that will be used for loading later on. The process then repeats from the first step 41 for another job.

FIG. 5 shows an example of a virtual SDF graph that may be used for this purpose. The virtual SDF graph has been obtained from the graph shown in FIG. 1b by adding nodes for virtual tasks 50 in front of each particular task 100. The virtual tasks 50 do not correspond to any real task during execution, but represent the delay due to the (as yet unknown) other tasks that will be assigned to the same processing unit as the particular task 100 that follows the virtual task 50. In addition, first additional edges 54 have been added from each original node 100 back to its preceding node for a virtual task 50. In the initial state of the graph these first additional each edges contain one token. These first additional edges 54 represent that completion of a task corresponding to a particular node 100 starts the delay time interval represented by the nodes for virtual tasks 50.

Furthermore, second additional edges 52 have been added from each particular original node 100 to the nodes for virtual tasks 50 that precede supplying nodes 100 that have edges toward the particular original node 100. Each of the second additional edges 52 is considered to be initialized with a respective number of tokens N1, N2, N3 that has yet to be determined. The second additional edges 52 represent the effect of buffer capacity between the tasks involved. The number of tokens N1, N2, N3 on the second additional edges 52 represent the number of signal stream chunks that can at least be stored in these buffers. The second additional edges 52 are coupled back to the nodes for virtual tasks 50 to express the fact that waiting times of a full cycle of tasks on a processing unit 10 may occur if a task has to be skipped because the buffer memory for supplying signal data to a downstream task is full.

It has been found that it can be proven that the capacity of the buffers may be computed from the virtual graphs of the type shown in FIG. 5, using the nearest integer equal to or above the value of the expression
(ΣCETᵢ)/ MCM
Herein MCM is the required real time throughput time (the maximum time between production of successive stream chunks) and WCETᵢ is the worst case execution time of tasks (labelled by i). The tasks involved in the sum depend on the buffer for which the capacity is computed, or, in terms of the SDF graph, on the nodes 100, 50 that occur between the starting node and end node of the second additional edge 52 that represents the buffer. The sum is taken over a selected number of tasks i that occur in a worst case path through the SDF graph from the end node to the starting node. Only “simple” paths should be considered: if the graph contains cycles, only paths should be considered that pass no more than once through any node.

For example, in the example shown in FIG. 5, consider the second additional edge 52 back from task A3 to virtual task W1. N3 (a number which is as yet unknown) tokens are initially present on this edge, representing a buffer size of N3 stream chunks for transmission of a data stream from task A1 to task A3. Now the buffer size N3 is computed by looking for paths through the graph from W1 (the end point of the edge with N3 tokens) to A3 (the starting point of this edge). There are two such paths: W1-A1-W2-A2-W3-A3, W1-A1-W3-A3. Due to loops, other paths also exist, for example W1-A1-W2-A2-W1-A2 (etc)-W3-A3, or W1-A1-W2-A2-W1-A21-W3-A2, but these should not be considered, because these paths pass twice through certain nodes. Nevertheless, in a more complicated graph, paths through back edges may contribute, as long as they are simple paths. For each of the two simple paths: W1-A1-W2-A2-W3-A3, W1-A1-W3-A3, the sum of the worst case execution times of the tasks represented by the nodes 100, 50 along the paths has to be determined, and the largest of those sums is used to compute the number of tokens N3.

Herein, worst-case execution times are associated with the virtual tasks 50. These worst-case execution times are set to T-Tᵢ. Herein T is a cycle time. The cycle time T of a particular task corresponds to a maximum allowable sum of the worst-case execution time of tasks that will be assigned to the same processing unit 10 together with the particular task (the execution time of the particular task being included in the sum). Preferably the same predetermined cycle time T is assigned to each task.

The worst case waiting time before a particular task can be executed anew is T-Tᵢ, where Tᵢ is the worst-case execution time of the particular task.

Similar computations are performed for the other buffer sizes, computing the numbers N1 and N2 in the example of the figure, using paths W1-A1-W2-A2 and W1-Al-W3-A3-W2-A2 for computing N1 and paths W2-A2-W3-A3 and W2-A2-W1-A1-W3-A3 for computing N2.

In this way, the minimum buffer capacity for buffering between tasks can be determined for the case wherein each task is executed by a processing unit 10 together with as yet unknown other tasks, provided that the tasks are given the opportunity to the be executed in cyclical fashion, if sufficient data and output buffer capacity are available.

In the fourth step 34 of FIG. 3, at run-time, when the process assigns tasks to the processing units 10, it tests for each processing unit whether the sum of the worst-case execution times of the tasks that are assigned to the same processor does not exceed the cycle time T assumed for any of the assigned tasks during off-line computation of the buffer sizes. If the assigned tasks exceed this cycle time, a different assignment of tasks to processing units is selected until an assignment has been found that does not exceed the assumed cycle times T. If no such assignment can be found the process reports that no real-time guarantee can be given.

If the fifth step 45 of FIG. 4 shows already off-line that the real time requirements cannot be met, the cycle times T assumed for some of the nodes 100 may optionally be reduced. On one hand this has the effect that delays introduced by corresponding nodes for a virtual task 50 is reduced, making it easier to meet the real time requirements. On the other hand this has the effect that less room exists for scheduling tasks together with such a task with a reduced assumed cycle time T during fourth step 34 of FIG. 3.

FIG. 6 shows a typical system for implementing the invention. A computer 60 is provided for performing the preliminary step 32 of FIG. 3. Computer 60 has an input for receiving information about the task structure of jobs and worst case execution times. A run time control computer 62 is provided for combining jobs. A user interface 64 is provided to enable a user to add or remove jobs (typically this is done implicitly by activating and deactivating functions of an apparatus such as a home video system). The user interface 64 is coupled to run time control computer 62, which has an input coupled to computer 60 for receiving execution parameters of the jobs that have been selected by computer 60. Run time control computer 62 is coupled to processing units 10 to control in which of processing units 10 which tasks will be activated and which execution parameters, such as buffer sizes, will be used on the processing units 10.

Computer 60 and run time control computer 62 may be the same computer. Alternatively, computer 60 may be a separate computer which is only nominally coupled to run time control computer 62 because parameters computed by computer 60 are stored or programmed in run time control computer 62, without requiring a permanent link between computers 60, 62. Run time control computer 62 may be integrated with processing units 10 in the same integrated circuit, or separate circuits may be provided for run time control computer 62 and processing units 10. As an alternative, one of processing units 10 may function as run time control computer 62.

### FURTHER EMBODIMENTS

By now it will be realized that the invention makes it possible to provide real time guarantees for concurrent execution of a combination of jobs that process potentially endless streams of signal data. This is done by a two-stage process. A first stage computes execution parameters such as buffer sizes and verifies real time capability for an individual job. This is done under the assumption that the tasks of the job are executed by processing units 10 that execute other, as yet unspecified task in series with the tasks of the job, using time multiplexing, provided that the total cycle time for that tasks executed by the processing unit does not exceed an assumed cycle time T. A second stage combines the jobs and sees to it that the worst case execution times of tasks that are assigned to the same processing unit 10 does not exceed the assumed cycle time T for any of these tasks.

In comparison with conventional SDF graph techniques there are a number of differences: (a) a two stage process is used (b) real time guarantees are first computed for individual jobs (c) for the executed combination of jobs no complete computation of real time guarantees is needed: it suffices to compute whether the sum of the worst case execution times of a sequence of tasks that is assigned to a processing unit 10 does not exceed any of the assumed cycle times of the assigned tasks and (d) the processing units 10 may skip execution of a task in a cycle of assigned tasks rather than waiting for sufficient input data and output buffer space, as is required for conventional SDF graph techniques.

This has a number of advantages: real time guarantees can be given for combinations of unrelated jobs, scheduling of such combinations requires less overhead and data supply and production of the jobs need not be synchronized.

It should be appreciated that the invention is not limited to the disclosed embodiment. First of all, although the invention has been explained using SDF graphs, no explicit graphs need of course be produced when the process is executed by a machine. It suffices that data that represents the essential properties of those graphs is generated and processed. Many alternative representations may be used for this purpose. In this context, it will be appreciated that the addition of waiting tasks to the graph has also been described merely as a convenient metaphor. No real tasks are added and many practical ways exist to account for effects that are equivalent to the effect of such conceptual waiting tasks.

Secondly, although the preliminary stage of selecting buffer sizes for individual jobs is preferably performed off-line, it may of course also be performed on-line, i.e. for a job just before the job is added to the jobs that are executed. The computation of buffer size is only one example of computation of execution parameters that may be computed. As has been explained the cycle times used for tasks themselves are another parameter that may be computed that may be determined in the first stage. As another example, the number of processing units that may perform the same task for successive chunks of a stream is another execution parameter that may be determined at the first stage in order to ensure real time capability. This may be realized for example by adding a task to the SDF graph to distribute chunks of a stream periodically over successive processors, adding copies of the task to process different chunks of the distributed stream and adding a combining task to combine the results of the copies into a combined output stream. Dependent on the number of copies compliance with the real time throughput condition can be assured in the assumed context.

Furthermore, more elaborate forms of assignment to processing units 10 may be used. For example, in one embodiment the preliminary stage may also involve imposition of the constraint that a group of tasks of a job should be executed by the same processing unit 10. In this case, fewer virtual tasks 50 for waiting time need be added (if the tasks in the groups are scheduled consecutively), or the virtual tasks 50 for waiting times may have smaller waiting times, representing the worst case execution time of part of the (as yet known) other tasks that may later be scheduled between tasks from the group. Effectively, the combined waiting times of virtual tasks 50 in front of the tasks in the group need only corresponds to one cycle time T, instead of n cycle times T which would be required when n tasks are considered without constraint to execution by the same processing unit 10. This may make it easier to guarantee that the real time constraints can be met. Furthermore the size of some of the required buffers can be reduced in this way.

Furthermore, if some form of synchronization of the data streams of the different jobs is possible, it is not necessary to use skipping of tasks during execution. This synchronization can be expressed in the SDF graphs.

Furthermore, although the invention has been explained for general purpose processing units 10, which can execute any task, instead, some of the processing units may be dedicated units, which are able to execute only selected tasks. As will be appreciated, this does not affect the principle of the invention, but only implies a restriction on the final possibilities of assignment of tasks to processing units. Also it will be appreciated that, although for the sake of clarity communication tasks have been omitted from the graphs (or are considered to be incorporated in the tasks), in practice communication tasks with corresponding timing and waiting relations may be added.

Furthermore, although the invention has been explained for an embodiment wherein each processing unit 10 uses a Round Robin scheduling scheme, in which tasks are given the opportunity to execute in a fixed sequence, it should be understood that any scheduling scheme may be used, as long as a maximum waiting time before a task gets the opportunity to execute can be computed for this scheduling scheme given a predefined constraint on the worst case execution time of (unspecified) tasks that are executed by the processing unit 10. Clearly, the type of sum of worst case execution times that is used to determine whether a task gets sufficient opportunities to execute depends on the type of scheduling.

Preferably, the jobs are executed with a processing system wherein jobs can be added and/or removed flexibly at run time. In this case, program code for the tasks of the jobs may be supplied in combination with computed information about the required buffer sizes and the assumed cycle times T. The information may be supplied from another processing system, or it may be produced locally in the processing system that executes the jobs. This information can then be used at run time to add jobs. Alternatively, the information required for scheduling execution of the jobs may be permanently stored in a signal processing integrated circuit with multiple processing units for executing the jobs. It may even be applied to an integrated circuit that is programmed to execute a predetermined combination of jobs statically. In the latter case, the assignment of tasks to processors need not be performed dynamically at run-time.

Hence, dependent on the implementation, the actual apparatus that executes the combination of jobs may be provided with full capabilities to determine buffer sizes and to assign tasks to processing units at run time, or only with capabilities to assign tasks to processing units at run time, or even only with a predetermined assignment. These capabilities may be implemented by programming the apparatus with a suitable program, the program being either resident or supplied from a computer program product such as a disk or an Internet signal representing the program. Alternatively, a dedicated hard-wired circuit may be used to support these capabilities.

1. A system for executing a combination of signal stream processing jobs, wherein the jobs contain tasks, each task to be performed by repeated execution of an operation that processes a chunk of data from a stream that the task receives and/or outputs a chunk from a stream that the task produces, each job comprising a plurality of the tasks in stream communication with one another, the system being arranged to perform a check to determine whether a real-time requirement will be met, the system comprising
a plurality of processing units mutually coupled for the communication of signal streams;
a preliminary computation unit that is arranged to perform a preliminary determination for each job individually, to determine execution parameters required for the job to support a required minimum stream throughput rate if each task of the job is executed in a respective context wherein opportunities to start execution of the task occur separated at most by a cycle time T defined for the task;
a control unit for run time selection a combination of jobs that should be executed in parallel;
an assignment unit arranged to assign groups of the tasks of the selected combination of jobs to respective ones of the processing units checking that for each particular processing unit a sum of worst case execution times for the tasks assigned to that particular processing unit does not exceed the defined cycle time T defined for any of the tasks assigned to the particular processing unit; the processing unit executing the selected combination of jobs concurrently, each processing unit time multiplexing execution of the group of tasks assigned to that processing unit.

2. A system according to claim 1, wherein the preliminary computation unit is arranged to compute buffer memory sizes of buffers for buffering the chunks between respective pairs of tasks, so that the buffer sizes are sufficient to ensure that the throughput rate will be met, buffer memory space of at least the computed size being reserved for buffering between the pair of tasks during execution.

3. A system according to claim 1, wherein at least one of the processing units is arranged to skip execution of a task of the group assigned to that processing unit if insufficient chunks are available to perform the operation of the task and/or insufficient buffer space is available to write a result chunk of the operation.

4. A method of processing a combination of signal stream processing jobs, the method comprising performing a check to determine whether a real-time requirement will be met, the method comprising the steps of
defining processing tasks each to be performed by repeated execution of an operation that processes a chunk of data from a stream that the task receives and/or outputs a chunk from a stream that the task produces;
defining a plurality of jobs, each comprising a plurality of the processing tasks in stream communication with one another;
performing a preliminary determination for each job individually, to determine execution parameters required for the job to support a required minimum stream throughput rate if each task of the job is executed in a respective context wherein opportunities to start execution of the task occur separated at most by a cycle time T defined for the task;
selecting a combination of jobs for parallel execution;
assigning groups of the tasks of the selected combination of jobs to respective processing units checking that for each particular processing unit a sum of worst case execution times for the tasks assigned to the particular processing unit does not exceed the defined cycle time T defined for any of the tasks assigned to the particular processing unit
executing the selected combination of jobs concurrently with the processing units time multiplexing execution of the groups of tasks.

5. A method according to claim 4, wherein said performing of the preliminary determination comprises computing buffer memory sizes of buffers for buffering the chunks between respective pairs of tasks so that the buffer sizes are sufficient to ensure that the throughput rate will be met, buffer memory space of at least the computes size being reserved for buffering between the pair of tasks during execution.

6. A method according to claim 5, wherein at least one of the buffer sizes for buffering data between a first and second task is computed by
identifying paths of successive tasks of the job, wherein in each path each successive tasks in the path depends on performance of a preceding task in the path to start operation, each path starting from the first task and ending at the second task
computing, for each identified path, information about a sum of worst case execution times of the tasks along the path, plus maximum waiting times before the tasks are given the opportunity to execute when executed in a respective context wherein opportunities to start execution of the task occur separated at most by a cycle time T defined for the task;
determining buffer size from a ratio of a largest of said sums for any of the identified paths and the required maximum throughput time between successive chunks.

7. A method according to claim 4, wherein said performing of the preliminary determination comprises selecting a sub-group of the tasks of the job for execution in time multiplexing by a common one of the processing units, it being determined whether the execution parameters required support the required minimum stream throughput rate if each task of the job is executed in a respective context wherein opportunities to start execution of the sub-group of tasks occur separated at most by a cycle time T defined for the sub-group.

8. A method according to claim 4, wherein execution of a task in said groups is skipped if insufficient chunks are available to perform the operation of the task and/or insufficient buffer space is available to write a result chunk of the operation.

9. A method according to claim 4, wherein said performing of the preliminary computation comprises performing determining whether it is possible to guarantee that throughput rate will always be met in said context.

10. A method according to claim 9, comprising reducing the cycle time T defined for at least one of the tasks if it cannot be guaranteed that the throughput rate will always be met and repeating said performing of the preliminary computation with the reduced cycle time.

11. A method according to claim 4, comprising generating information that is equivalent to a representation of a Synchronous Data Flow (SDF) graph, and computing the parameters using graph analysis equivalent techniques.

12. A device for executing a combination of signal stream processing jobs, wherein the jobs contain tasks each to be performed by repeated execution of an operation that processes a chunk of data from a stream that the task receives and/or outputs a chunk from a stream that the task produces, each job comprising a plurality of the processing tasks in stream communication with one another, the device being arranged to perform a check to determine whether a real-time requirement will be met, the device comprising
a plurality of processing units coupled for the communication of signal streams;
a control unit (for run time selection a combination of jobs that should be executed in parallel;
- a circuit arranged to assign groups of the tasks of the selected combination of jobs to respective ones of the processing units checking that for each particular processing unit a sum of worst case execution times for the tasks assigned to that particular processing unit does not exceed a defined cycle time T defined for any of the tasks assigned to the particular processing unit the processing unit executing the selected combination of jobs concurrently, each processing unit time multiplexing execution of the group of task assigned to that processing unit.

13. An apparatus for computing execution parameters required for jobs, wherein the jobs contain tasks each to be performed by repeated execution of an operation that processes a chunk of data from a stream that the task receives and/or outputs a chunk from a stream that the task produces, each job comprising a plurality of the processing tasks in stream communication with one another, the apparatus being arranged to perform a preliminary computation for each job individually, to determine execution parameters required for the job to support a required minimum stream throughput rate if each task of the job is executed in a respective context wherein opportunities to start execution of the task are separated at most by a cycle time T defined for the task.

14. An apparatus according to claim 13, wherein said performing of the preliminary computation comprises computing buffer memory sizes of buffers for buffering the chunks between respective pairs of tasks so that the buffer sizes are sufficient to ensure that the throughput rate will be met, buffer memory space of at least the computes size being reserved for buffering between the pair of tasks during execution.

15. An apparatus according to claim 14, wherein at least one of the buffer sizes is for buffering data between a first and second task is computed by
identifying paths of successive tasks of the job, wherein in each path each successive task depends on performance of a preceding task in the path to start operation, each path starting from the first task and ending at the second task
computing, for each identified path, information about a sum of worst case execution times of the tasks along the path, plus maximum waiting times before the tasks are given the opportunity to execute when executed in a respective context wherein opportunities to start execution of the task occur separated at most by a cycle time T defined for the task
determining buffer size by from a ratio of a largest of said sums for any of the identified paths and the required maximum throughput time between successive chunks.

16. An apparatus according to claim 14, wherein said performing of the preliminary computation comprises performing determining whether it is possible to guarantee that throughput rate will always be met in said context, and reducing the cycle time defined for at least one of the tasks if it cannot be guaranteed that the throughput rate will always be met and repeating said performing of the preliminary computation with the reduced cycle time.

17. A method of processing a combination of signal stream processing jobs, the method comprising performing a check to determine whether a real-time requirement will be met, the method comprising the steps of
defining processing tasks each to be performed by repeated execution of an operation that processes a chunk of data from a stream that the task receives and/or outputs a chunk from a stream that the task produces;
defining a plurality of jobs, each comprising a plurality of the processing tasks in stream communication with one another;
selecting a combination of jobs for parallel execution;
assigning groups of the tasks of the selected combination of jobs to respective processing units checking that for each particular processing unit a sum of worst case execution times for the tasks assigned to the particular processing unit does not exceed predetermined cycle time T defined for any of the tasks assigned to the particular processing unit
executing the selected combination of jobs concurrently, time multiplexing execution of the groups of tasks.

18. A method of computing execution parameters for executing a combination of signal stream processing jobs, the method comprising
defining processing tasks each to be performed by repeated execution of an operation that processes a chunk of data from a stream that the task receives and/or outputs a chunk from a stream that the task produces;
defining a plurality of jobs, each comprising a plurality of the processing tasks in stream communication with one another;
performing a preliminary computation for each job individually, to determine execution parameters required for the job to support a required minimum stream throughput rate if each task of the job is executed in a respective context wherein opportunities to start execution of the task are separated at most by a cycle time T defined for the task.

19. A computer program product containing instructions to make a programmable processor perform the method of claim 17.

20. A computer program product containing instructions to make a programmable processor perform the method of claim 18.
